(19) United States
(12) Patent Application Publication
(10) Pub. No.: US 2009/0046849 A1
(43) Pub. Date: Feb. 19, 2009

(54) Data integrity and non-repudiation method

(75) Inventors: David P. Jablon, Westborough, MA (US); Joel G. Landau, Simi Valley, CA (US)

Correspondence Address: STEPTOE & JOHNSON, LLP, 2121 AVENUE OF THE STARS, SUITE 2800, LOS ANGELES, CA, 90067, US

(73) Assignee: BALLY GAMING, INC., Las Vegas, NV (US)

(21) Appl. No.: 12/108,392

(22) Filed: Apr. 23, 2008

Related U.S. Application Data
(60) Provisional application No. 60/913,517, filed on Apr. 23, 2007.

(51) Int. Cl. H04L 9/28

(52) U.S. Cl. 380/28

(57) ABSTRACT

A method is disclosed for establishing data integrity and non-repudiation without hashing and without performing a bit to bit comparison of the message. The method includes: generating a random symmetric key for use with a symmetric encryption algorithm; generating a random sequence having a plurality of elements; separating a message into a plurality of blocks, wherein each block has a size less than or equal to the block size of the symmetric algorithm less the size of a digital signature of one of the plurality of elements; generating a signature for each of the plurality of elements; encrypting a concatenation of each of the plurality of blocks of the message with a corresponding signature, the encrypting performed with the symmetric encryption algorithm and the random symmetric key; and communicating the encrypted concatenation to a gaming device.

### CROSS-REFERENCE TO RELATED APPLICATIONS

This application is related to U.S. Provisional Patent Application No. 60/913,517, filed Apr. 23, 2007, entitled DATA INTEGRITY AND NON-REPUDIATION which is herein incorporated by reference in its entirety. This application is related to co-pending U.S. patent application Ser. No. ______filed ______, entitled DATA INTEGRITY AND NON-REPUDIATION SYSTEM.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

This disclosure relates to information security, and more specifically to applied cryptography.

### BACKGROUND

Cryptography is the art and science of preparing, transmitting and reading messages in a form intended to prevent the message from being read by those not privy to secrets associated with the form. Cryptography is practiced in and widely appreciated for a wide array of applications, including gaming, computer security, healthcare information security, banking information security, military communications, mathematics, intellectual property protection and many others.

A ciphertext, sometimes referred to as a cipher, is the resultant of a message that has been transformed by a cipher to conceal its meaning. The cipher systematically replaces the contents of a message by substitutes, singly, in pairs, in other polygraphs or other more sophisticated methods. By way of example, for many years, newspapers have published a daily cryptogram puzzle, an elementary form of letter-substitution cipher which includes ciphertext to be decrypted.

A simple example is illustrated by the following ciphertext: “RVW HQM GU CSRGUP CIFCMD SQKWD OAQK RVW FQAB. UQR RVW NWABD QA RVW KQUWM QA RVW UZKJWA QO HQJD MQZ VCLW. RWSVUGTZW GD VQF MQZ IWCAU RQ OGUE RVW DFWWR DNQR GU MQZA FQAB. CUE RVCR DWIID.—IWDIGW WCDRWAJAQQB.” The term cleartext refers to the form of the message able to be read by any party. The corresponding cleartext of the cipher above is, “The joy in acting always comes from the work. Not the perks or the money or the number of jobs you have. Technique is how you learn to find the sweet spot in your work. And that sells.—Leslie Easterbrook” (“Easterbrook Quote”) This example is a simple letter-substitution cryptogram, which is easy to solve even without the key to its construction (A=C, B=J, C=S, D=E, E=W, F=O, G=P, H=V, I=G, J=H, K=B, L=I, M=K, N=U, O=Q, P=N, Q=T, R=A, S=D, T=R, U=Z, V=L, W=F, X=Y, Y=M, Z=X). In contrast, modern ciphers are designed to be impossible to solve by anyone that doesn't know the relevant key.

Public key cryptography provides further benefits, by using a pair of related keys, including a private key that is typically a closely held secret, and a corresponding public key which may (typically) be widely revealed.

Public key digital signature schemes include methods for signing and verifying digital signatures. The signing method creates a data string called a “signature” that is associated with a digital message to bind the message to the signing entity's private key. The private key is associated with a corresponding public key, which the recipient of the message uses with a verification method to verify that the received message was, in fact, signed using the associated private key.

A public key encryption scheme includes methods for encrypting and decrypting messages, in which a message encrypted with a party's public key can only be decrypted using the associated private key.

### SUMMARY

Briefly, and in general terms, the disclosure is directed towards information security and establishing data integrity and non-repudiation. More particularly, the disclosure is directed towards data integrity and non-repudiation techniques that are accomplished without performing hashing and without performing a bit to bit comparison. Still further, the disclosure is directed to establishing data integrity and non-repudiation in a gaming environment.

In one embodiment, the method includes: generating a random symmetric key for use with a symmetric encryption algorithm; generating a random sequence having a plurality of elements; separating a message into a plurality of blocks, wherein each block has a size less than or equal to the block size of the symmetric algorithm less the size of a digital signature of one of the plurality of elements; generating a signature for each of the plurality of elements; encrypting a concatenation of each of the plurality of blocks of the message with a corresponding signature, the encrypting performed with the symmetric encryption algorithm and the random symmetric key; and communicating the encrypted concatenation to a gaming device.

In another embodiment, the method includes using a gaming server or other host device to generate a random symmetric key for use with a symmetric encryption algorithm, the key having a block size of at least 512 bits. The server generates a random sequence having a plurality of elements by generating an elliptic curve signature for each of the plurality of elements. The server separates software or information into a plurality of blocks, each block having a size equal to the block size of the symmetric encryption algorithm less the size of the elliptic curve signature. The server then encrypts a concatenation of each of the plurality of blocks of the software with a corresponding elliptic curve signature, wherein the encrypting is performed with the symmetric encryption algorithm and a random symmetric key. Once accomplished the server communicates the encrypted concatenation to a gaming device or other device.

In still another embodiment, the method uses the symmetric encryption algorithm is a Rijndael variant. Similarly, the elliptic curve signature has a length of at least 256 bits. Likewise, the random sequence may be a geometrically increasing sequence. The elliptic curve signature can also be generated with a variant of an ElGamal signature algorithm. And the elliptic curve signature may, but is not required to omit hashing of the information.

In yet another embodiment, there is disclosed a method wherein a server generates a random symmetric key for use with a symmetric encryption algorithm. The server generates a random sequence having a plurality of elements and a signature for each of the plurality of elements. The server separates software or information into a plurality of blocks, each block having a size less than or equal to the block size of the symmetric encryption algorithm less the size of the signature. Thereafter, the server encrypts a concatenation of each of the plurality of blocks of the software with a corresponding signature using the symmetric encryption algorithm and a random symmetric key. Finally the server communicates the encrypted concatenation to another device.

Other features will become apparent from the following detailed description, taken in conjunction with the accompanying drawings, which illustrate by way of example, the features of the various embodiments.

### BRIEF DESCRIPTION OF THE DRAWINGS

FIG. 1 is a gaming machine that may be used in association with the method of establishing data integrity and non-repudiation;

FIG. 2 is a gaming system that may be used for establishing data integrity and non-repudiation;

FIG. 3 is a logic flow diagram of a method of establishing data integrity and non-repudiation; and

FIG. 4 is a logic flow diagram of a method of establishing data integrity and non-repudiation.

### DESCRIPTION

Protecting information security is critical in today's information intensive society. Verifying the accuracy of information to provide trustworthiness is essential. In many different environments, sensitive data and information is transmitted from one location to another. The receiving party must be able to verify the authenticity of the information and the sender must be able to rely upon the information being transmitted securely.

In the gaming environment, for example, there are many techniques used to establish data integrity and non-repudiation. As more and more gaming devices and systems use the Internet and other communication processes to expand the capabilities of the gaming devices, the need to protect and trust the information exchanged between the devices and/or their hosts increases.

Accordingly, as more and more players play electronic wagering games, both gaming establishments and players seek assurances that the software and information which the games rely upon are protected from corruption. Attacks on gaming software and/or gaming data may result in a game failing to properly function and/or the theft of personal credit card or other related information. Corruption may occur due to criminal hacking and/or data failure of electronic components, such as network communication devices, memories, hard disks, optical disks and other components.

Components of a gaming device may include logic arrays, memories, analog circuits, digital circuits, software, firmware and processors such as microprocessors, field programmable gate arrays, application specific integrated circuits, programmable logic devices and programmable logic arrays.

In response to data security concerns, various regulatory agencies have imposed rules for gaming establishments with regard to electronic gaming. Several of the rules are directed to authentication of information that is transferred from one medium to another.

A gaming device may be implemented via one or more of a personal computer, server computer, set top box, video game system, mobile phone, personal digital assistant and other electronic devices. The gaming device software may include an operating system, including variations of the Linux, UNIX, MS-DOS, Microsoft Windows, Palm OS, and Apple Mac OS X operating systems and others.

The methods, functionality and features described herein may be embodied in whole or in part in software which operates on a standalone, server, or distributed gaming system and may be in the form of firmware, an application program, an applet, a plug-in, a COM object, a dynamic linked library, a script, one or more subroutines, or an operating system component or service.

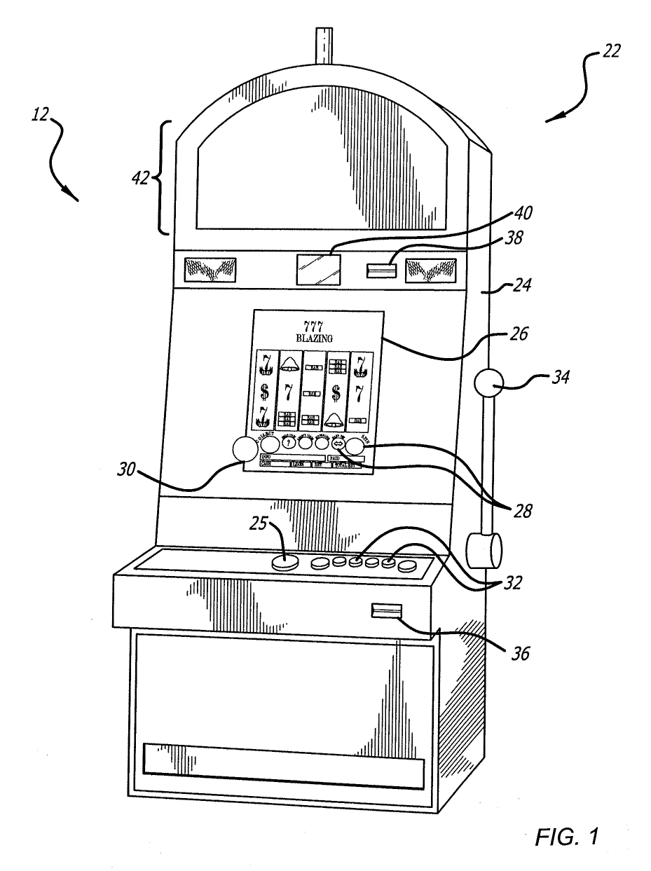

Referring now to the drawings, wherein like references numerals denote like or corresponding parts throughout the drawings, and more particularly to FIG. 1, there is shown a typical gaming machine 12. The gaming machine 12 includes a gaming cabinet 24 that houses a display screen 26. Optionally, the display 26 may include a touch screen system (not shown). In other embodiments, the video reel slot game can be replaced by any game, including, but not limited to mechanical slots, video keno, video poker, video blackjack, video roulette, Class II bingo, games of skill, or games of chance involving some player skill. For the sake of brevity and clarity, the following disclosure and examples of the game is a slot-type game, but those skilled in the art will appreciate that any of the above-referenced games or any others may be presented by the gaming machine 12.

The game machine 12 includes a dedicated set of buttons 28 having functions such as, but not limited to, a collect button (or cash-out), select lines button, bet per line button, max bet button, and a spin button. A max bet button 30 is also disclosed and allows the player to place a maximum wager. These functions and buttons can vary depending on what input is required for a given game 22.

The gaming machine 12 shown in FIG. 1 also includes a player interface having a set of buttons 32 for the game presented on the display 26. The buttons 32 function as input mechanisms and may include mechanical buttons, electromechanical buttons, or touch screen buttons. While FIG. 1 illustrates a gaming machine 12 having both touch screen buttons and mechanical buttons, other contemplated embodiments have only mechanical buttons or touch screen buttons. According to one embodiment, the buttons 32 are backlit to indicate whether the button is active. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated herein by reference. Additionally, other input devices, such as, but not limited to, a touch pad, track ball, mouse, switches, toggle switches, are included with the gaming machine to also accept player input. Optionally, one or more handles 34 may be “pulled” by a player to initiate a slots-based game.

In yet another embodiment, a cellular phone or other input device (e.g., PDA), separate and apart, from the gaming machine 12 may also be used to input various player choices and information to enhance the player's interactive experience with the gaming machine. In this embodiment, the gaming machine 12 also includes an IR sensor, RF sensor, BLUETOOTH receiver, or other means for receiving input from a cellular phone or other wireless input devices. Furthermore, inputting information via these devices provides an added level of security as any key presses may be hidden from view. In yet another embodiment, a player may call or send a text message or a short message service (SMS) to the gaming machine.

As illustrated in FIG. 1, the gaming machine 12 may include a ticket reader/ticket printer slot 36 that is associated with a cashless gaming system (not shown). According to one embodiment, the slot 36 is used for the ticket reader and ticket printer. Accordingly, the same slot 36 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher. In another embodiment, the gaming machine may allow a player insert credit onto the gaming machine through an electronic funds transfer from a player's account. In this embodiment the slot may be a card reader for reading a credit or debit card from the player.

Additionally, each gaming machine 12 may be in communication with a player tracking system (not shown). The player tracking system allows a casino to monitor the gaming activities of various players. The player tracking system typically includes a database of all qualified players (i.e., those players who have enrolled in a player rating or point accruing program). Generally, the database for the player tracking system is separate from the gaming machines. Additionally, the player tracking system is able to store data relating to a player's gaming habits as well as the player's preferences for gaming machine configuration. That is, a player can accrue player points that depend upon the amount and frequency of their wagers. Casinos can use these player points to compensate the loyal patronage of players. For example, casinos may award or “comp” a player free meals, room accommodations, tickets to shows, and invitations to casino events and promotional affairs.

The player tracking system is operatively connected to one or more input components located on or within the gaming machine 12. These input components include, but are not limited to, a player card slots 38 for receiving a player tracking card, a keypad or equivalent, and a display 40. Accordingly, the gaming activity of the players may be tracked. Alternatively, the gaming machine includes no slot at all. If the gaming machine does not include a player card slot, the players may input player identification via a touch screen, keypad, or other input mechanisms that are associated with the player tracking system in lieu of inserting a player tracking card.

In another embodiment, each gaming machine 12 includes an Internet connection or other known network connections to link the plurality of gaming machines together and/or to provide network access. According to one embodiment, the Internet connection is used for web browsing, prize redemption, or access to other gaming or non-gaming information. With the various gaming machines in communication with one another (or a system host), the gaming machines 12 may participate in the group bonus feature. In one embodiment, the bonus is randomly paid out to a single gaming machine, and alternatively, the bonus is paid out to all or all eligible gaming machines. It has been contemplated that to be eligible, a player must be betting the maximum amount or have played a certain amount of money over a period of time, played for a certain amount of time, or any other determining feature.

The main cabinet 24 of the gaming machine 12 also houses a CPU, circuitry, and software for receiving signals from the player-activated buttons 28 and one or more handles 34, operating the games, and transmitting signals to the game display and speakers. In one embodiment, the game 22 and any other features are operated by separate processors that are in communication with one another. In yet another embodiment, the game 22 and the other features are operated remotely via one or more servers.

In various embodiments, one or more game programs may be stored in a memory (not shown) comprising a read only memory (ROM), volatile or non-volatile random access memory (RAM), a hard drive or flash memory device or any of several alternative types of single or multiple memory devices or structures. Optionally, each gaming machine 12 includes one or more data repositories for storing data. Examples of information stored by the gaming machines 12 include, but are not limited to, accounting data, maintenance history information, short and/or long-term play data, real-time play data, and sound data. In one embodiment, the data repository also stores display content configurations for various games and gaming machines.

In FIG. 1, the gaming machine 12 includes a top box 42 and a main cabinet 12. According to one embodiment, the top box is a separate and distinct component that is affixed to the main cabinet. In another embodiment, the top box is an area that is partitioned from the main cabinet. Alternatively, the top box and the main cabinet may be contiguous areas with the outward appearance of two distinct components. The top box may include a secondary display for displaying game information (e.g., name of the game, animation, one or more pay tables, game information, one or more help menus, progressive jackpot or game information, tournament game information, or any combination thereof) or non-game related information (e.g., news, advertisements, messages, promotions, or any combination thereof). In one embodiment, the secondary display presents a secondary game such as, but not limited to, a bonus game, progressive game, or a continuation game of the primary game. In yet another embodiment, the top box also includes a display glass that includes the name of the game, artwork, game instructions, pay table, or other information relating to one or more games presented on the gaming machine 12. In one embodiment, the secondary display may be used as the indicator 16 during the bonus feature, where the secondary display flashes or displays a symbol or color.

One of ordinary skill in the art will appreciate that not all gaming machines have all these components and may have other components in addition to, or in lieu of, those components mentioned here. Furthermore, while these components are viewed and described separately, various components may be integrated into a single unit in some embodiments.

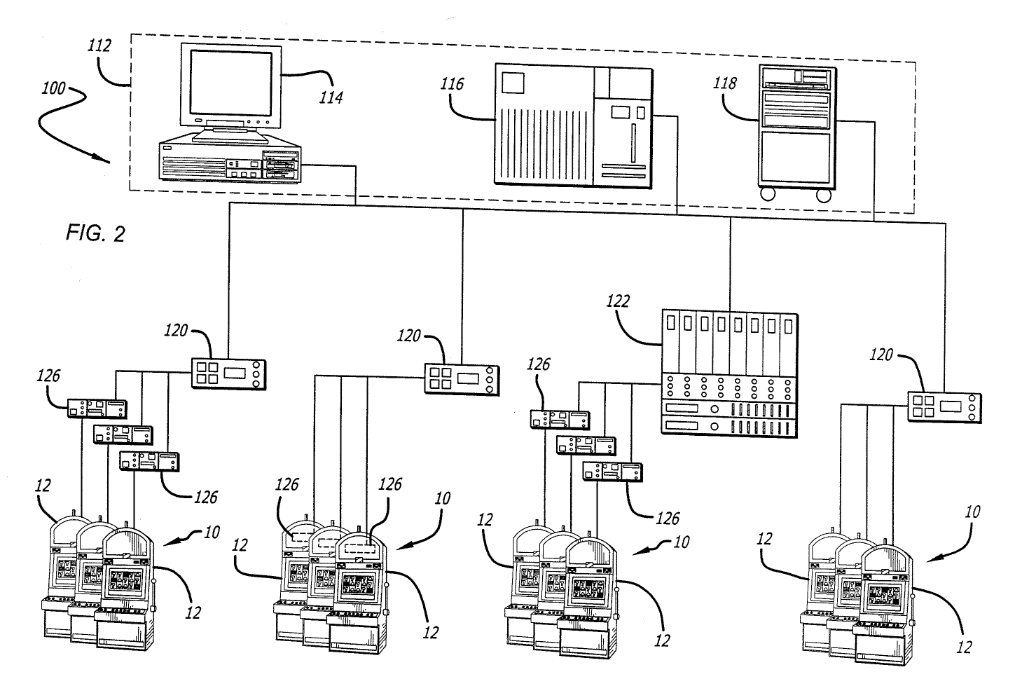

Similarly, in another embodiment, the data integrity and non-repudiation techniques may be used in a gaming system. Referring now to FIG. 2, a typical casino gaming system 100 is illustrated. The casino gaming system 100 comprises one or more gaming machines 12 and may include one or more banks of associated gaming devices 10. The gaming machines 12, as illustrated in FIG. 2, act as terminals for interacting with a player playing a casino game. Networking components facilitate communications between a system server 112 and game management units 126 that control displays for carousels of gaming machines 12 across a network. Game management units (GMU's) 126 connect gaming machines to networking components and may be installed in the gaming machine cabinet or external to the gaming machine 12. The function of the GMU 126 is similar to the function of a network interface card connected to a desktop personal computer (PC). Some GMU's 126 have much greater capability and can perform such tasks as presenting and playing a game using a display (not shown) operatively connected to the GMU 126. In one embodiment, the GMU 126 is a separate component located outside the gaming machine 12. Alternatively, in another embodiment, the GMU 126 is located within the gaming machine 12. Optionally, in an alternative embodiment, one or more gaming machines 12 connect directly to a network and are not connected to a GMU 126. In certain embodiments, the GMU 126 may have the capacity to act as the bonus feature module.

The gaming machines 12 are connected via a network to a network bridge 120, which is used for networking, routing and polling gaming machines, including slot machines. The network bridge 120 connects to a back end system 112. Optionally, the gaming machines 12 may connect to the network via a network rack 122, which provides for a few number of connections to the back end system 112. Both network bridge 120 and network rack 122 may be classified as middleware, and facilitate communications between the back end system 112 and the game management units 126. The network bridges 120 and network rack 122 may comprise data repositories for storing network performance data. Such performance data may be based on network traffic and other network related information. Optionally, the network bridge 120 and the network rack 122 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The back end system 112 may be configured to comprise one or more servers. The type of server employed is generally determined by the platform and software requirements of the gaming system. In one embodiment, as illustrated in FIG. 5, the back end system 112 is configured to include three servers: a slot floor controller 114, a casino management server 116 and a casino database 118. The slot floor controller 114 is a part of the player tracking system for gathering accounting, security and player specific information. The casino management server 116 and casino database 118 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

Overall, the back end system 112 performs several functions. For example, the back end system 112 can collect data from the slot floor as communicated to it from other network components, and maintain the collected data in its database. The back end system 112 may use slot floor data to generate a report used in casino operation functions. Examples of such reports include, but are not limited to, accounting reports, security reports, and usage reports. The back end system 112 may also pass data to another server for other functions. Alternatively, the back end system 112 may pass data stored on its database to floor hardware for interaction with a game or game player. For example, data such as a game player's name or the amount of a ticket being redeemed at a game may be passed to the floor hardware. Additionally, the back end system 112 may comprise one or more data repositories for storing data. Examples of types of data stored in the system server data repositories include, but are not limited to, information relating to individual player play data, individual game accounting data, gaming machine accounting data, cashable ticket data, sound data, and optimal display configurations for one or more displays for one or more system game.

As is typical, at least one server includes a storage device for storing information and a processor for executing an algorithm for acquiring and processing the information. Once the information is processed by the processor, the information can be sent to one or more of the gaming devices for use by the gaming device.

Of course, one of ordinary skill in the art will appreciate that the gaming system 100 may also comprise other types of components, and the above illustrations are meant only as examples and not as limitations to the types of components or games used in a casino gaming system presenting a group play feature.

Generally, authentication refers to the application of cryptographic techniques to establish trustworthiness of any of (a) the source of a message, (b) non-repudiation of the source of the message and (c) integrity of the message. Gaming establishments provide for electronic games on standalone gaming devices, networked gaming devices and Internet gaming. Messages, such as operating system programs and gaming software may be transferred from a read only memory (“ROM”) to a random access memory (“RAM”), from a hard disk device (“HDD”) to a RAM, from a digital video disk (“DVD”) to a RAM, from a server computer's network storage device (“NSD”) to a gaming device's RAM, from a server computer's RAM to a personal computer's RAM as well as many other routes in and/or between standalone and/or networked electronic devices.

When designing a cryptography system for securing information in the gaming industry, electronic gaming developers consider the intellectual property rights of their competitors. For example, there are at least 15 U.S. patents related to cryptography including hash based authentication techniques as applied to electronic gaming systems.

Hash based authentication techniques have long been used with regard to gaming devices (see Keane, Great Britain patent number GB 2,121,569 disclosed on May 12, 1982, incorporated herein by reference). Keane applied RSA cryptography to gaming devices. RSA was disclosed on Dec. 14, 1977 (see U.S. Pat. No. 4,405,829, incorporated herein by reference).

The teachings of the following four patents, incorporated herein by reference, in combination with RSA, are fundamental to applied cryptography:

| Inventors | Patent No. | Issue Date | Focus |
|---|---|---|---|
| Ehrsam et al. | 3,962,539 | Jun. 08, 1976 | Data Encryption |
| | | | Standard |
| Hellman, Diffie, | 4,200,770 | Apr. 29, 1980 | Diffie-Hellman |
| Merkle | | | agreement |
| Hellman-Merkle | 4,218,582 | Aug. 19, 1980 | Public key systems |
| Merkle | 4,309,569 | Jan. 08, 1982 | Tree authentication |

Additionally, the disclosures of the following ten patents, incorporated herein by reference, teach basic cryptographic techniques that may be applied in developing a secure gaming environment.

| Inventors | Patent No. | Issue Date | Focus |
|---|---|---|---|
| Okamoto et al. | 4,625,076 | Nov. 25, 1986 | ESIGN signatures |
| Fiat, Shamir | 4,748,668 | May 31, 1988 | Fiat-Shamir identification |
| Matyas et al. | 4,850,017 | Jul. 18, 1989 | Control vectors |
| Miyaguchi, | 4,850,019 | Jul. 18, 1989 | FEAL cipher |
| Shimizu | | | |
| Brachtl et al. | 4,908,861 | Mar. 13, 1990 | MDC-2, MDC-4 hashing |
| Schnorr | 4,995,082 | Feb. 19, 1991 | Schnorr signatures |
| Guillou, | 5,140,634 | Aug. 18, 1992 | GQ identification |
| Quisquater | | | |
| Lai, Massey | 5,214,703 | May 25, 1993 | IDEA cipher |
| Kravitz | 5,231,668 | Jul. 27, 1993 | DSA signatures |
| Micali | 5,276,737 | Jan. 04, 1994 | Fair key escrow |

Traditionally, authentication in the gaming industry is achieved by one of two basic methods. Authentication may include a bit to bit comparison of a trusted cleartext message to a copy of the cleartext message. For textbook cryptographic authentication methods, see MENEZES, van OORSCHOT and VANSTONE, HANDBOOK OF APPLIED CRYPTOGRAPHY 385-488 (1997) incorporated herein by reference. Because bit to bit comparison techniques may be inefficient depending on the size and locations of the messages and the computer hardware being employed, it has become commonplace to employ hash based authentication techniques, where a relatively short bit-string representation of a message acts as a surrogate for the message.

Authentication may include a comparison of a trusted hash of the trusted cleartext message to a hash of the copy of the cleartext message. Additionally, the hashes, cleartexts and ciphertexts may be encrypted and/or authenticated to provide for additional security. An example of a cryptographic technique applied to the hashes, cleartexts and ciphertexts is a public key digital signature.

A hash function maps binary strings of arbitrary length to a fixed length. In order to be responsible with regard to security, a hash function should be selected in order to create a message digest. Message digests are hashes which are computationally infeasible to generate an input collision. The term input collision refers to two independent inputs that have a common hash value.

For example purposes, the following table shows the hash value of the Easterbrook Quote with regard to four commonly known and publicly available hash functions.

| Hash Function | Hash |
|---|---|
| CRC32 | CC3585E9 |
| MD5 | 45C790D349E815C3C485A7B8309F65E5 |
| SHA-1 | 03664EA40FC2129986B7A6EAE47AD4CD9B25B14A |
| SHA-2-512 | CD4EC6BB109A342B33326FE1DB4EBE0563BA180E170AC5B |
| | D285139701AAE47C36D62B998835B2BD00F51D53212E1CB8 |
| | 90CF6D58827506C08BCBA26A4643D2C7C |

The CRC32 differs from the others in not being designed to resist collisions by a cryptographically sophisticated adversary, and furthermore, has insufficient size to prevent brute-force collision search. The remaining hash-based and comparison authentication techniques are considered to be computationally efficient and generally responsible with regard to protecting operating system software, gaming program software and specific game data with regard to electronic gaming. However, the art of hash based comparison authentication techniques is mature. Furthermore, people continuously attempt to crack cryptographic techniques, such that techniques that were once respected for widespread use have been later shown to have weaknesses.

Diversification is an additional approach to securing information as it diffuses the ability of hackers to crack a wide variety of cryptographic techniques. It is also generally recognized that the security of a cryptographic system should rely on as few assumptions as practical. Many hybrid cryptographic systems rely on the security of two or more underlying cryptographic methods, such as a hash algorithm, a symmetric cipher, and a public key digital signature or encryption scheme. The following embodiment is directed to establishing data integrity and non-repudiation without the application of hash algorithms or bit to bit comparisons of a message to be protected.

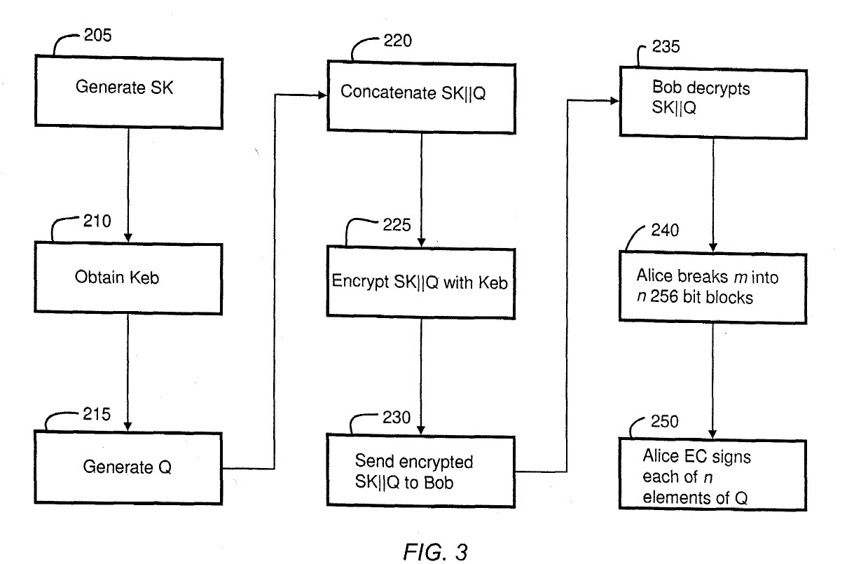

The disclosed algorithm may be used with gaming devices and/or systems. The algorithm functions in association with a processor to provide the data integrity and non-repudiation capabilities. More particularly, referring now to FIG. 3, there is shown a logic flow diagram of a method of establishing data integrity and non-repudiation. The method is described with regard to two parties, “Alice” and “Bob.” Alice and Bob may be actual people, a server computer and a client computer, a gaming server and a gaming machine, a hard disk and a RAM within a gaming machine, representative elements of a state machine, or any other system with two points of communication. The terms Alice and Bob are not intended to represent the names of fictitious or actual people, such as Alice Hyatt or Bob Newhart, but rather represent abstract roles of two arbitrary participants as is traditional in descriptions of cryptographic protocols.

After obtaining the information from a storage device, the information is processed in accordance with the following algorithm. Alice may generate a random symmetric key SK (step 205). Symmetric key cryptography is well suited for high rates of data throughput. Because the symmetric key is relatively short with regard to keys for public key encryption, a random number generator can efficiently generate a random symmetric key SK. In selecting a symmetric algorithm for a cryptographic system, one may consider the desired level of security, the size of an effective key and the complexity of the algorithm. Examples of symmetric key algorithms include AES, xmx, Rijndael, DES, Serpent and Twofish.

Alice and Bob may desire to share SK and keep it secret. In order to communicate SK between Alice and Bob, a public key technique may be utilized. In public key cryptography, each of Alice and Bob has their own public key e and private key d. Properly selected, it is computationally infeasible to determine d knowing e. The public key e defines the encryption transformation Eₑ and the private key d defines the decryption transformation D_{d}.

Public key cryptographic techniques, in general, are slow relative to symmetric techniques. In practice, public-key cryptography is more frequently used in the transfer of symmetric keys and small data such as checking account numbers, passwords and secret sequences of characters. Examples of public-key algorithms include Diffie-Hellman, RSA, Rabin, ElGamal, McEliece, Merkle-Hellman knapsack, Chor-Rivest knapsack, Goldwasser-Micali probabilistic and Blum-Goldwater probabilistic.

Additional responsible techniques for public key digital signature include the Digital Signature Algorithm technique and the Pintsov-Vanstone Signature with Message Recovery technique.

As applied, Alice obtains an authentic copy of Bob's public key K_{eb} (step 210). Alice creates a subset of a randomly selected sequence wherein the subset Q includes n elements (215). The term sequence refers to an ordered list of non-repeating characters or elements. A sequence's elements may include integers and/or polynomials. Well known sequences include Cauchy, Farey, Thue-Morse, Fibonacci, arithmetic and geometric sequences. Alice concatenates SK with a randomly selected sequence, resulting in SK∥Q (step 220). In any case, the elements of the list shared by Alice and Bob are associated in a one-to-one correspondence with blocks of a message to be sent from Alice to Bob.

Alice encrypts SK∥Q with K_{eb} (step 225). Alice sends (SK∥Q)_{Keb} to Bob (step 230). Bob decrypts (SK∥Q)_{Keb} using K_{db} (step 235).

Alice breaks message m into n 256 bit blocks (step 240). Alice creates a digital signature for each of the n elements of Q (step 250). Elliptic curve public key digital signatures provide high security relative to other public key techniques having the same length signatures. Although estimates vary, it has been estimated that a key size of 4096 bits for RSA gives the same level of security as 313 bits in an elliptic curve system.

The signature for each of the n elements of Q may be generated using an elliptic curve Massey-Omura technique, an elliptic curve ElGamal technique, an elliptic curve Digital Signature Algorithm technique and any of numerous others. For implementation of elliptic curve applications, see WASHINGTON, ELLIPTIC CURVES NUMBER THEORY AND CRYPTOGRAPHY 159-174 (2003), incorporated herein by reference.

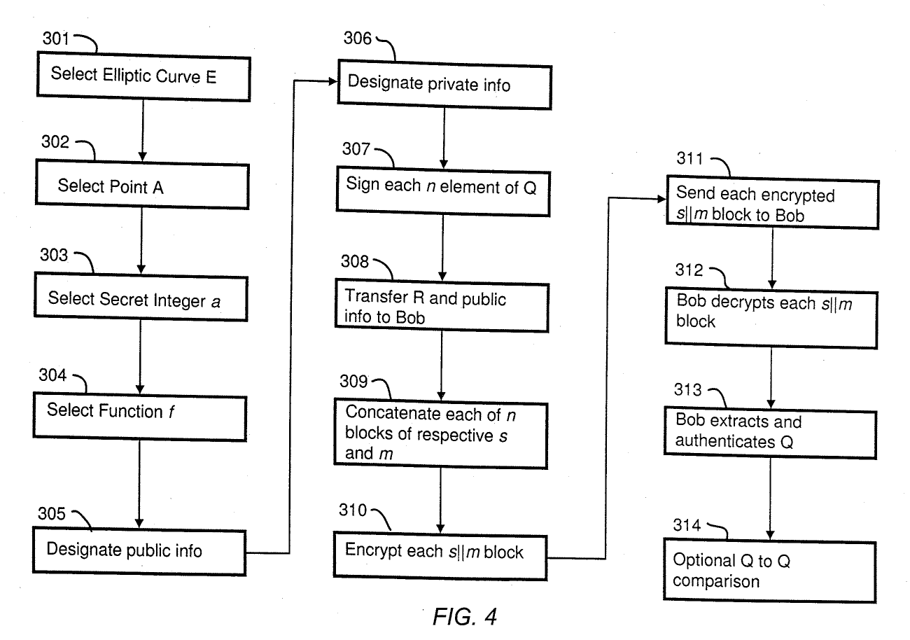

Referring now to FIG. 4, there is shown a logic flow diagram of a method of establishing data integrity and non-repudiation. Alice generates a public key as follows: Alice selects elliptic curve E over finite field F_{q} such that the discrete log problem is hard for E(F_{q}) (step 301). Alice chooses point A within E(F_{q}) (step 302). Alice chooses a secret integer a (step 303). Alice computes B=aA. Alice chooses a functions: E(F_{q})→Z (step 304). For responsible security establishment, the image off should be large and only a small number of inputs should produce any given output.

Alice designates her public information as E, (F_{q}),f, A and B (step 305). Alice designates a as private (step 306).

Alice proceeds to sign each of n elements of Q with the following technique (step 307): Alice selects a random integer k with gcd(k,N)=1 and computes R=kA. Alice computes s k⁻¹(Q−af(R)) (mod N); Alice's signature of each of n signed blocks of Q includes R and s.

Alice responsibly communicates R and Alice's public information E, (F_{q}), f, A and B to Bob (step 308).

Alice concatenates each of n signatures s of sequence Q with a corresponding each of n blocks of message m (step 309). Alice encrypts each of n blocks of s∥m with a block cipher algorithm that utilizes a suitably large block size, such as xmx or a 512 bit block version of Rijndael (step 310). Alice sends each of n blocks of(s∥m)_{SK} to Bob (step 311). In response to Alice sending each of n blocks of (s∥m)_{SK} to Bob, Alice may dispose of SK to further enhance security.

For an overview of xmx, see M'RAIHI, NACCACHE, STERN and VAUDENAY, XMX—A FIRMWARE-ORIENTED BLOCK CIPHER BASED ON MODULAR MULTIPLICATIONS (1995) incorporated herein by reference.

Bob decrypts each of n blocks of (s∥m)_{SK} with SK and the same symmetric algorithm which Alice used to encrypt each of n blocks of s∥m (step 312). In response to the decryption, Bob may dispose of SK to further enhance security. Bob then extracts each of n elements of Q and verifies Alice's signature s for each of n blocks of Q with the following function (step 313): Q is authentic if Q=(f(R)(B)+sR)/A. Optionally, Bob may determine if each of n blocks of authenticated Q match a predetermined sequence (step 314).

If Q is authentic, then Bob accepts the sequence of n blocks of message m as having a trusted sequence. Because each of n blocks of s∥m is encrypted with a symmetric block cipher, corruption of any of the blocks of m or any re-sequencing of the blocks of m would result in Q being determined not authentic. Should Q be non-authentic then gaming device methods may be terminated, the gaming device may be deactivated and an alarm may be activated to notify appropriate authorities.

Furthermore, because a responsible symmetric algorithm is employed and SK is responsibly communicated between Alice and Bob, the communication of each of n blocks of (s∥m)_{SK} is accepted as being transferred in confidence, with non-repudiation and data integrity. In turn, transferred message m may be trusted.

Records of various steps of the data integrity and non-repudiation method may be stored at a gaming machine, at a server and/or transferred to a regulatory authority. Additionally, copies of the sequences and the public, private and secret keys may be authentically communicated and stored with a regulatory authority. Moreover, trusted copies of gaming software, programs, data and operating system software and programs may be stored at the regulatory authority.

Furthermore, the method described above may be applied to communicating updates of an operating system, gaming software and other data.

In sum, the disclosed data integrity and non-repudiation method omits the use of hash functions. Additionally, the method omits a bit to bit comparison of a trusted message m with a communicated message m. The disclosed method is responsible for securing data communications over a network. Moreover, the method may be performed efficiently with computing devices relative to public key cryptography over the entire message m.

Embodiments described herein involve combinations of method steps and system elements. These steps and elements may be combined in a plurality of ways to accomplish the same goals. One of ordinary skill in the art will appreciate that not all embodiments have all these components and each may have other components in addition to, or in lieu of, those components mentioned herein. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

1. A method for securing information, comprising:
a gaming server generating a random symmetric key for use with a symmetric encryption algorithm, the key having a block size of at least 512 bits;
the gaming server generating a random sequence having a plurality of elements;
generating an elliptic curve signature for each of the plurality of elements;
the gaming server separating a gaming software into a plurality of blocks, each block having a size equal to the block size of the symmetric encryption algorithm less the size of the elliptic curve signature;
encrypting a concatenation of each of the plurality of blocks of the gaming software with a corresponding elliptic curve signature, the encrypting being performed using the symmetric encryption algorithm and a random symmetric key; and
communicating the encrypted concatenation to a gaming device.

2. The method of claim 1, wherein the symmetric encryption algorithm is a Rijndael variant.

3. The method of claim 2, wherein the elliptic curve signature has a length of at least 256 bits.

4. The method of claim 1, wherein the random sequence is a geometrically increasing sequence.

5. The method of claim 4, wherein the elliptic curve signature is generated with a variant of an ElGamal signature algorithm.

6. The method of claim 4, wherein generating the elliptic curve signature omits hashing.

7. The method of claim 4, wherein the gaming software is an upgrade to a video poker wagering game.

8. The method of claim 1, wherein the random symmetric key is disposed of in response to communicating the encrypted concatenation to a gaming device.

9. A method for securing information, comprising:
a gaming server generating a random symmetric key for use with a symmetric encryption algorithm;
the gaming server generating a random sequence having a plurality of elements;
generating a signature for each of the plurality of elements;
the gaming server separating a gaming software into a plurality of blocks, each block having a size less than or equal to the block size of the symmetric encryption algorithm less the size of the signature;
encrypting a concatenation of each of the plurality of blocks of the gaming software with a corresponding signature, the encryption being performed using the symmetric encryption algorithm and a random symmetric key; and
communicating the encrypted concatenation to a gaming device.

10. A method for securing information, comprising:
a server generating a random symmetric key for use with a symmetric encryption algorithm having a block size of at least 512 bits;
the server generating a random sequence having a plurality of elements;
generating an elliptic curve signature for each of the plurality of elements;
the server separating a information into a plurality of blocks, each block having a size equal to the block size of the symmetric encryption algorithm less the size of the elliptic curve signature;
encrypting a concatenation of each of the plurality of blocks of the information with a corresponding elliptic curve signature, the encrypting being performed using the symmetric encryption algorithm and a random symmetric key; and
communicating the encrypted concatenation to a another device.

11. The method of claim 10, wherein the symmetric encryption algorithm is a Rijndael variant.

12. The method of claim 11, wherein the elliptic curve signature has a length of at least 256 bits.

13. The method of claim 10, wherein the random sequence is a geometrically increasing sequence.

14. The method of claim 13, wherein the elliptic curve signature is generated with a variant of an ElGamal signature algorithm.

15. The method of claim 13, wherein generating the elliptic curve signature omits hashing.

16. The method of claim 10, wherein the gaming software is an upgrade to a video poker wagering game.

17. The method of claim 10, wherein the random symmetric key is disposed of in response to communicating the encrypted concatenation to a gaming device.

18. A method for securing information, comprising:
a server generating a random symmetric key for use with a symmetric encryption algorithm;
the server generating a random sequence having a plurality of elements;
generating a signature for each of the plurality of elements;
the server separating information into a plurality of blocks, each block having a size less than or equal to the block size of the symmetric encryption algorithm less the size of the signature;
encrypting a concatenation of each of the plurality of blocks of the information using a corresponding signature, the encryption being performed using the symmetric encryption algorithm and a random symmetric key; and
communicating the encrypted concatenation to another device.
